(19) United States
(12) Patent Application Publication
(10) Pub. No.: US 2015/0298345 A1
(43) Pub. Date: Oct. 22, 2015

(54) DOVETAIL PROCESSING APPARATUS AND PROCESSING METHOD FOR HORIZONTALLY LOADING WOOD PLATE

(71) Applicant: GM TECH COL, LTD, Busan (KR)

(72) Inventors: SEONG LEE, II, Busan (KR); SEUNG DAE LEE, Busan (KR)

(21) Appl. No.: 14/442,819

(22) PCT Filed: Jun. 5, 2014
(86) PCT No.: PCT/KR2014/004982

§ 371 Date: May 14, 2015

(30) Foreign Application Priority Data
Jul. 8, 2013 (KR) 10-2013-0079889

(51) Int. Cl. B27F 1/08

(52) U.S. Cl. CPC B27F 1/08

(57) ABSTRACT

The present invention comprises a horizontal loading platform on an upper part of a base frame in order to horizontally load a wood panel and comprises a spindle mounting platform to which is attached, in horizontally rotatable fashion, a spindle adapted to mount a processing bit at the front side of the base frame, wherein the spindle mounting platform is transferred at least in the vertical direction and the left-to-right horizontal direction so as to process the wood panel.

### TECHNICAL FIELD

The present invention relates to apparatus and method for forming tails and pins in ends of wood panels.

### BACKGROUND ART

Generally, wood panels for furniture or construction can be connected to each other in various fashions. A biscuit joint, a mortise and tenon joint, a dovetail joint, etc. are representative examples of methods for coupling of wood panels.

In such coupling methods, a junction between two wood panels is machined for coupling before the panels are coupled to each other.

The dovetail joint not only provides high coupling force but also is aesthetically pleasing because the junction between the wood panels is exposed to the outside. Thus, the dovetail joint is the most widely used wood panel coupling method.

For such dovetail joints, pins and tails are respectively formed in the two wood panels to be coupled to each other. In the past, such pins and tails were manually formed in the wood panels by a saw or the like. However, recently, various processing methods using a router have been introduced.

For processing a wood panel using a router, a template or jig is first manufactured to have a desired shape and then disposed on the wood panel. Thereafter, a router bit is moved along the perimeter of the template or jig, whereby the wood panel can be machined in the same shape as that of the template.

FIG. 1 is a conceptual view illustrating dovetail coupling.

A plurality of tails 11 is formed in a first wood panel 10. A plurality of pins 21 is formed in a second wood panel 20. Subsequently, the first wood panel 10 and the second wood panel 20 are coupled to each other by joining the tails 11 and the pins 21 to each other.

FIG. 2 illustrates a dovetail processing method according to a conventional technique.

The technique of FIG. 2 introduces a method for forming tails or pins in a wood panel using a router. This method includes three operations.

(1) A template or jig 20 is installed on a worktable.

Here, the perimeter of the template or jig 20 must have size and shape corresponding to those of a dovetail to be processed.

(2) Thereafter, a wood panel 30 is placed upright on the worktable and fixed in place.

(3) Subsequently, tails or pins are formed using a router 40.

However, this conventional method has the following problems.

In the conventional method, the wood panel is placed upright and fixed in placed, and tails or pins are formed in the upper end of the wood panel. In the case of a comparatively long wood panel, for example, a wood panel for construction, the router must be disposed at a height of about 2 m to 3 m. Moreover, a worker must be positioned higher than the router so as to manipulate the router. Therefore, there is danger of the worker falling, and there is a problem of an increase in working time.

Furthermore, in the conventional method, all kinds of templates or jigs corresponding to dovetails to be processed are required. The templates and jigs are generally expensive, and there are various shapes of dovetails depending on the shapes and angles of tails and the shapes and angles of pins. Thus, there is a cost burden, and it is difficult to store templates or jigs by size and angle.

Furthermore, processing using such a router requires a skilled worker. An unskilled worker may cause a problem of deterioration in quality, and in some cases, a template or jig may be damaged.

Meanwhile, a conventional technique related to the present invention was proposed in Korean Patent Unexamined Publication No. 10-2012-0115919, entitled “TEMPLATE FOR DOVETAIL AND CUTTING DEVICE INCLUDING THE SAME” (Publication Date: Oct. 19, 2012).

### DISCLOSURE

### Technical Problem

Accordingly, the present invention has been made keeping in mind the above problems occurring in the prior art, and an object of the present invention is to provide a dovetail processing apparatus that is configured such that a wood panel is horizontally disposed while tails or pins are formed in the wood panel, whereby even when the wood panel is comparatively long, there is no need for high elevation work, a template or jig is not required, and an unskilled worker can easily form a dovetail, and to provide a dovetail processing method using the apparatus.

### Technical Solution

In order to accomplish the above object, in an aspect, the present invention provides a dovetail processing apparatus having a structure for horizontally loading a wood panel, the dovetail processing apparatus including: a base frame; a horizontal loading platform provided on an upper surface of the base frame so that the wood panel is horizontally loaded on the horizontal loading platform; a spindle mounting platform disposed ahead of the base frame, with a spindle horizontally and rotatably mounted to the spindle mounting platform, the spindle being provided for installation of a processing bit; a spindle-rotation drive unit provided on the spindle mounting platform so as to rotate the spindle; a platform moving unit provided to move the spindle mounting platform at least in a vertical direction and a horizontal lateral direction perpendicular to an axial direction of the spindle; and a control unit provided to control the spindle-rotation drive unit and the platform moving unit.

The control unit may be connected to an input unit that receives information about at least a maximum diameter of a dovetail bit, an angle of tails, a depth of the tails, and an overall length of a processing surface of the wood panel. The control unit may include a processed-form computation unit computing the number, configuration, and shape of tails and pins to be formed according to the information input to the input unit, and a drive controller controlling the spindle-rotation drive unit and the platform moving unit according to the information computed by the processed-form computation unit.

The processed-form computation unit may compute the number of tails to be formed using the information about the maximum diameter of the dovetail bit and the overall length of the processing surface of the wood panel.

The processed-form computation unit may compute the number, configuration, and shape of pins to be formed depending on the number, configuration, and shape of tails to be formed.

The platform moving unit may include: a vertical moving block guided by the base frame so as to be vertically movable, the vertical moving block including a loading-platform horizontal-guide unit guiding horizontal lateral movement of the spindle mounting platform; a vertical moving drive unit provided to vertically move the vertical moving block; and a lateral moving drive unit provided on the vertical moving block and operated such that the spindle mounting platform can be moved along the loading-platform horizontal-guide unit in the horizontal lateral direction.

In another aspect, the present invention provides a dovetail processing method using a structure for horizontally loading a wood panel, the dovetail processing method including: an operation of horizontally loading a first wood panel on a horizontal loading platform; an operation of fixing the first wood panel on the horizontal loading platform in such a way that a wood panel fastener holds an upper surface of the first wood panel loaded on the horizontal loading platform; an information input operation of inputting information about tails and pins to be formed to an input unit; an operation of forming tails in the first wood panel using a dovetail bit in such a way that the control unit controls to move a spindle mounting platform upward, downward, leftward, and rightward according to the information input to the input unit, the spindle mounting platform being provided with a spindle to which the dovetail bit is mounted, the spindle being horizontally and rotatably provided; an operation of removing the first wood panel loaded and fixed on the horizontal loading platform from the horizontal loading platform after the operation of forming the tails has been completed; an operation of loading a second wood panel on the horizontal loading platform in the horizontal direction; an operation of fixing the second wood panel on the horizontal loading platform in such a way that the wood panel fastener holds an upper surface of the second wood panel loaded on the horizontal loading platform; a bit changing operation of removing the dovetail bit from the spindle and mounting a spiral bit to the spindle; and an operation of forming pins in the second wood panel in such a way that the control unit controls to move the spindle mounting platform upward, downward, leftward, and rightward according to the information input in the information input operation, the spindle mounting platform being provided with the spindle to which the spiral bit is mounted. The tails of the first wood panel and the pins of the second wood panel may be coupled to each other in a dovetail joint manner.

In a further aspect, the present invention provides a dovetail processing method using a structure for horizontally loading a wood panel, the dovetail processing method including: an operation of horizontally loading a first wood panel on a horizontal loading platform; an operation of fixing the first wood panel on the horizontal loading platform in such a way that a wood panel fastener holds an upper surface of the first wood panel loaded on the horizontal loading platform; an information input operation of inputting information about tails and pins to be formed to an input unit; an operation of forming pins in the first wood panel using a spiral bit in such a way that the control unit controls to move a spindle mounting platform upward, downward, leftward, and rightward according to the information input to the input unit, the spindle mounting platform being provided with a spindle to which the spiral bit is mounted, the spindle being horizontally and rotatably provided; an operation of removing the first wood panel loaded and fixed on the horizontal loading platform from the horizontal loading platform after the operation of forming the pins has been completed; an operation of loading a second wood panel on the horizontal loading platform in the horizontal direction; an operation of fixing the second wood panel on the horizontal loading platform in such a way that the wood panel fastener holds an upper surface of the second wood panel loaded on the horizontal loading platform; a bit changing operation of removing the spiral bit from the spindle and mounting a dovetail bit to the spindle; and an operation of forming tails in the second wood panel in such a way that the control unit controls to move the spindle mounting platform upward, downward, leftward, and rightward according to the information input in the information input operation, the spindle mounting platform being provided with the spindle to which the dovetail bit is mounted. The pins of the first wood panel and the tails of the second wood panel may be coupled to each other in a dovetail joint manner.

The information about the tails and pins input in the information input operation may comprise information about at least a maximum diameter of the dovetail bit, an angle of the tails, a depth of the tails, and an overall length of a processing surface of the wood panel.

The dovetail processing method may further comprise an operation of computing a processing form after the information input operation in such a way that the control unit computes numbers, configurations, and shapes of tails and pins to be formed according to the information input in the information input operation.

The operation of computing the processing form may include computing a number, configuration, and shape of pins to be formed corresponding to a number, configuration, and shape of tails.

### Advantageous Effects

The present invention provides a dovetail processing apparatus having a structure for horizontally loading a wood panel and a dovetail processing method using the same. In this invention, a wood panel is horizontally disposed while tails or pins are formed in the wood panel, whereby even when the wood panel is comparatively long, there is no need for high elevation work. Furthermore, a template or jig is not required. In addition, an unskilled worker can easily form a dovetail.

### DESCRIPTION OF DRAWINGS

FIG. 1 is a conceptual view illustrating dovetail coupling;

FIG. 2 illustrates a dovetail processing method according to a conventional technique;

FIG. 3 is a perspective view illustrating a dovetail processing apparatus according to an embodiment of the present invention;

FIG. 4 is a view showing a process of processing a wood panel using the dovetail processing apparatus of FIG. 3;

FIG. 5 is a control block diagram of an embodiment of the present invention;

FIG. 6 is a reference photograph showing a dovetail bit mounted to a spindle;

FIG. 7 is a plan view of tails to be formed in a first wood panel;

FIG. 8 is a view showing dimensions of critical portions of the tails to be formed in the first wood panel;

FIG. 9 is of views showing dimensions of critical portions of pins to be formed in a second wood panel; and

FIG. 10 is a reference photograph showing a spiral bit mounted to a spindle.

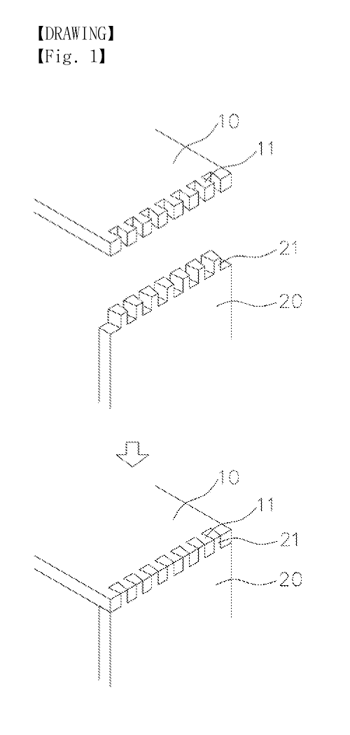

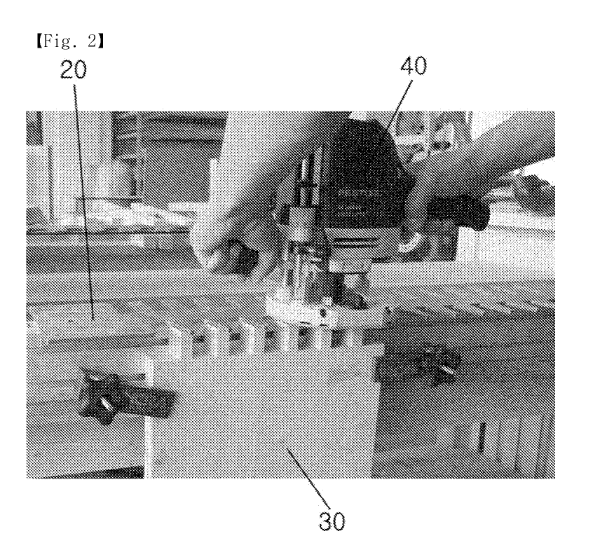

### BEST MODE

Hereinafter, a preferred embodiment of the present invention will be described in detail with reference to the attached drawings, such that those skilled in the art can easily implement the present invention. The present invention is realized in various manners and is not limited to the following embodiment. Furthermore, in the drawings, portions which are not related to the present invention should be omitted to explain the present invention more clearly. Reference should be made to the drawings, in which similar reference numerals are used throughout the different drawings to designate similar components.

In the specification, when the explanatory phrase “a part includes a component” is used, this means that the part may further include other components rather than excluding the components, so long as special explanation is not given.

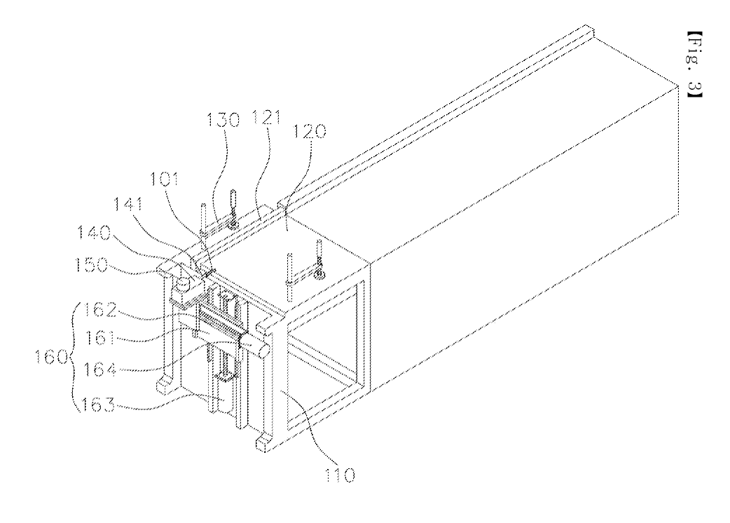

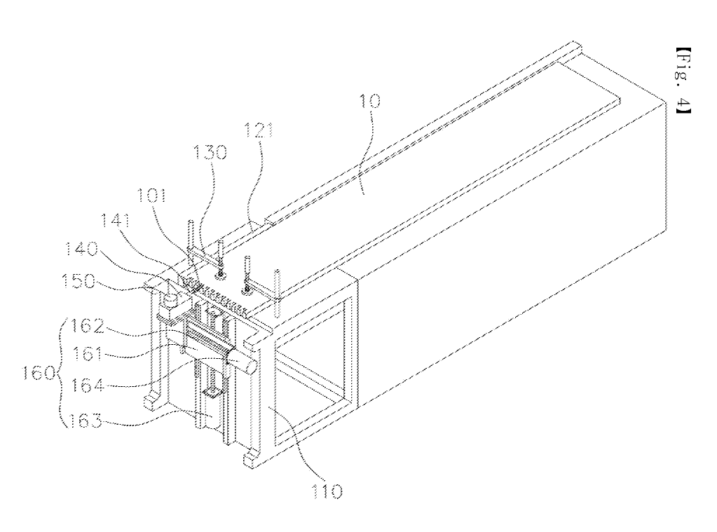

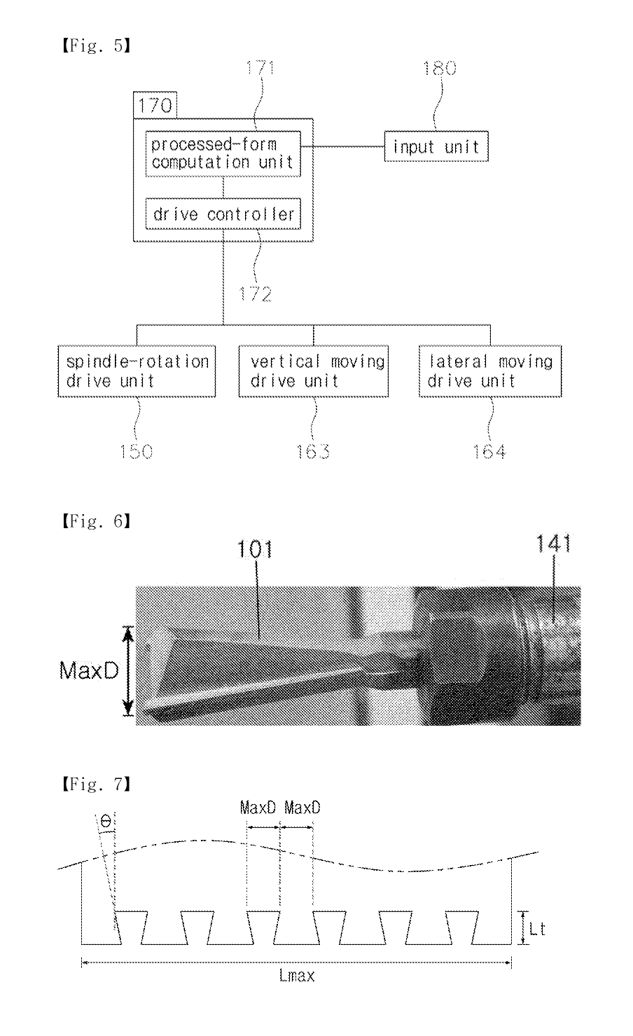

FIG. 3 is a perspective view illustrating a dovetail processing apparatus according to an embodiment of the present invention. FIG. 4 is a view showing a process of processing a wood panel using the dovetail processing apparatus of FIG. 3. FIG. 5 is a control block diagram of an embodiment of the present invention.

The dovetail processing apparatus includes a base frame 110, a horizontal loading platform 120, a wood panel fastener 130, a spindle mounting platform 140, a spindle-rotation drive unit 150, a platform moving unit 160, and a control unit 170.

The base frame 110 functions as a base for installation of the other elements and can have various shapes.

The horizontal loading platform 120 is provided on an upper surface of the base frame 110.

The horizontal loading platform 120 is a part on which a wood panel is horizontally loaded and supported. In this embodiment, although the horizontal loading platform 120 has been illustrated as having a panel shape, it may be configured in such a way that a plurality of bars is connected to each other. A guide protrusion 121 is provided on a side portion of the horizontal loading platform 120 and provides a reference point with respect to a side edge of the wood panel.

Therefore, the wood panel is loaded on the horizontal loading platform 120 such that a side edge thereof comes into close contact with the guide protrusion 121.

Furthermore, the dovetail processing apparatus includes the wood panel fastener 130 such as a clamp or the like so as to prevent the wood panel horizontally loaded on the horizontal loading platform 120 from undesirably moving during a dovetail processing operation.

The platform moving unit 160 is provided on the front of the base frame 110.

The platform moving unit 160 is provided to move the spindle mounting platform 140, which will be explained in detail later herein, in the vertical direction and the horizontal lateral direction perpendicular to an axial direction of a spindle 141

The platform moving unit 160 includes a vertical moving block 161, a vertical moving drive unit 163, and a lateral moving drive unit 164.

The vertical moving block 161 is guided by the base frame 110 so as to be vertically movable. Furthermore, a loading-platform horizontal-guide unit 162 is provided on an upper end of the vertical moving block 161 and guides lateral movement of the spindle mounting platform 140.

The vertical moving drive unit 163 is provided to vertically move the vertical moving block 161. The vertical moving drive unit 163 may include a cylinder or, alternatively, a motor and a rotation conversion unit that converts rotational motion of the motor into linear motion.

Furthermore, the lateral moving drive unit 164 is provided on the vertical moving block 161 and operated such that the spindle mounting platform 140 can be moved along the loading-platform horizontal-guide unit 162 in the horizontal lateral direction.

Therefore, the spindle mounting platform 140 mounted to the vertical moving block 161 can be moved in front of the base frame 110 in the vertical or lateral direction or in the vertical and lateral direction.

The above-mentioned construction of the platform moving unit 160 is proposed only for illustrative purpose, and it can be easily understood that the construction of the platform moving unit 160 may be modified into various forms.

The spindle mounting platform 140 is disposed ahead of the base frame 110 and substantially moved by the platform moving unit 160.

The spindle 141 to which a processing bit (a dovetail bit or a spiral bit) is mounted is horizontally and rotatably provided on the spindle mounting platform 140. In addition, the spindle-rotation drive unit 150 for rotating the spindle 141 is provided on the spindle mounting platform 140.

In this embodiment, the spindle-rotation drive unit 150 comprises a motor.

The control unit 170 is provided to control the spindle-rotation drive unit 150 and the platform moving unit 160 (in detail, the vertical moving drive unit 163 and the lateral moving drive unit 164).

Furthermore, the control unit 170 is connected to an input unit 180, for example, including a touch screen or the like.

The input unit 180 receives information about at least the maximum diameter of the dovetail bit, the angle of the tails, the depth of the tails, and the overall length of a processing surface of the wood panel.

The control unit 170 includes a processed-form computation unit 171 that computes the number, configuration, and shape of tails and pins to be processed according to information input through the input unit 180, and a drive controller 172 that controls the spindle-rotation drive unit and the platform moving unit according to information computed by the processed-form computation unit 171.

Moreover, the input unit 180 is provided in a touch screen form so that it can function as an output unit. In this case, preferably, the number, configuration, and shape of tails and pins to be processed that have been computed by the processed-form computation unit 171 can be pre-displayed by the input unit (180, the touch screen). In addition, the input unit 180 is preferably configured such that an operator can use the input unit 180 to change the number and configuration of tails and pins.

Hereinafter, an embodiment of a dovetail processing method using the dovetail processing apparatus having the above-mentioned construction will be described in detail.

Although the method according to this embodiment will be explained as being conducted in such a way that that tails are formed in a first wood panel before pins are formed in a second wood panel, the sequence of processing the first and second panels may be reversed.

(1) Operation of Loading the First Wood Panel

First, the first wood panel 10 is horizontally loaded on the horizontal loading platform 120 of the dovetail processing apparatus

Here, the first wood panel 10 is disposed such that a side edge of the first wood panel 10 comes into close contact with the guide protrusion 121.

Then, the positions of the first wood panel 10 and the spindle mounting platform 140 can be set based on the same reference point by virtue of the guide protrusion 121.

(2) Operation of Fixing the First Wood Panel in Place

The wood panel fastener 130 holds an upper surface of the first wood panel 10, which has been loaded on the horizontal loading platform 120 in the operation of loading the first wood panel, and thus fixes the first wood panel 10 in place, thus preventing the first wood panel 10 from undesirably moving during processing operation.

(3) Operation of Inputting Information

This operation may be conducted before operation (1) and (2) or, alternatively, after operation (1) and (2).

The input unit 180 receives information about the tails and pins to be formed.

The information input in this operation includes information about at least the maximum diameter of the dovetail bit, the angle of the tails, the depth of the tails, and the overall length of the processing surface of the wood panel.

Furthermore, in this operation, information about the diameter of the spiral bit may also be input.

FIG. 6 is a reference photograph showing the dovetail bit 101 mounted to the spindle 141.

The maximum diameter of the dovetail bit 101 is information about the diameter MaxD of the thickest portion of the dovetail bit.

FIG. 7 is a plan view of tails to be formed in the first wood panel and shows variables that must be input through the input unit.

The overall length of the processing surface of the wood panel is denoted as Lmax, the angle of the tail is denoted as θ, the depth of the tail is denoted as Lt.

As such, the information input in this operation includes information about at least the maximum diameter of the dovetail bit, the angle of the tails, the depth of the tails, and the overall length of the processing surface of the wood panel.

(4) Operation of Computing a Processing Form

The number, configuration, and shape of tails and pins to be processed are computed using information input in operation (3).

The processed-form computation unit 171 of the control unit 170 computes the number, configuration, and shape of tails and pins to be processed according to information input through the input unit 180.

First, a reference processing number (Num Work) is calculated by Lmax and MaxD.

Num_Work is defined by a quotient of Lmax/(MaxD×2) and is an integer.

Num_Work is the same as the number of tail grooves and is greater by one than that of tails having a complete shape.

After the reference processing number is calculated, the number of basic tails is calculated.

In addition, the number, configuration, and shape of tails of the first wood panel 10 are computed through the following computation process.

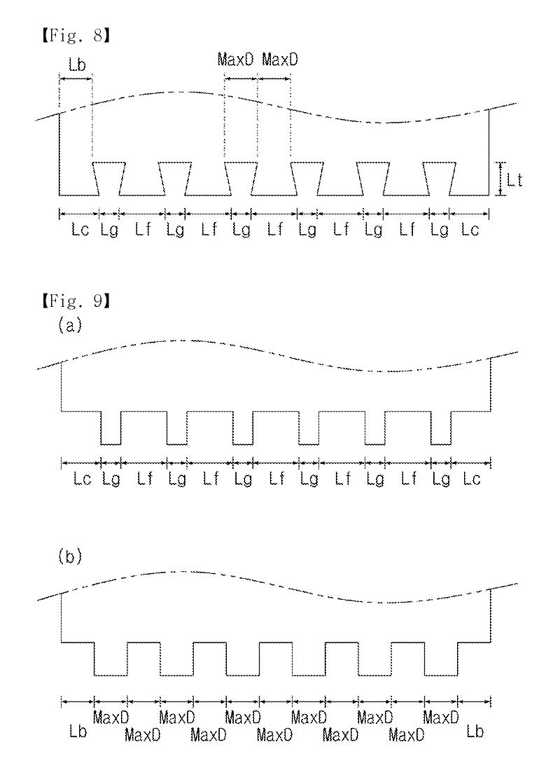

FIG. 8 is a view showing dimensions of critical portions of the tails to be formed in the first wood panel 10.

Lb=(Lmax−(MaxD×Num_Work+MaxD×(Num_Work−1)))/2

Lc=Lb+tan θ×Lt

Lf=MaxD+tan θ×Lt×2

Lg=MaxD−tan θ×Lt×2

The dimensions of the critical portions of the tails are determined by the above formulas.

That is, the number, configuration, and shape of tails are indicated by Lmax, MaxD, θ, and Lt.

The operation of forming tails in the first wood panel is conducted in such that the dovetail bit moves in the vertical direction to form each tail groove.

Subsequently, the number, configuration, and shape of pins to be formed in the second wood panel 20 are computed.

FIG. 9 is of views showing dimensions of critical portions of pins to be formed in the second wood panel 20, wherein FIG. 9a is a plan view showing an upper surface of the second wood panel, and FIG. 9b is a bottom view showing a lower surface thereof.

As shown in FIG. 9, the number, configuration, and shape of pins to be formed in the second wood panel 20 are determined depending on the number configuration, and shape of tails formed in the first wood panel.

After the number, configuration, and shape of pins to be formed in the second wood panel have been determined, the spiral bit is moved at a predetermined inclined angle from an upper reference point to a lower reference point in a pin forming operation. In this way, pin grooves are formed in the second wood panel.

Of course, when the pins are formed, the diameter Ds of the spiral bit with regard to a moving path of the spiral bit must be taken into account.

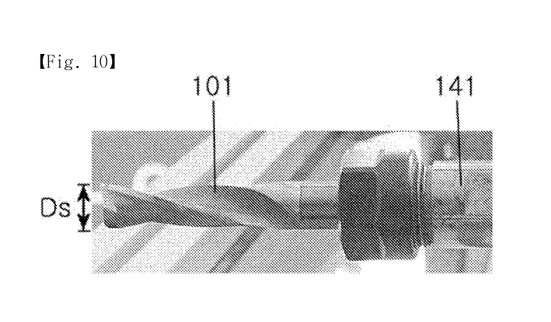

FIG. 10 is a reference photograph showing the spiral bit 101 mounted to the spindle 141.

Meanwhile, the number, configuration, and shape of tails of the first wood panel and pins of the second wood panel are displayed on the touch screen (in this embodiment, the input unit 180) to the operator. The operator can use the touch screen to adjust the number, configuration, and shape of tails and pins.

(5) Operation of Forming Tails

After the operation of computing the processing form has been completed, the drive controller 172 of the control unit 170 controls the vertical moving drive unit 163 and the lateral moving drive unit 164 to move the spindle mounting platform 140 in the vertical and lateral directions, thus forming tails in the first wood panel 10.

Here, the dovetail bit 101 has been mounted to the spindle 141 of the spindle mounting platform 140, and the drive controller 172 also drives and controls the spindle-rotation drive unit 150. Substantially, the spindle 141 is rotated by the spindle-rotation drive unit 150, and the dovetail bit 101 is rotated along with the spindle 141. In addition, the dovetail bit 101 is moved along the same path as a path along which the spindle mounting platform 140 moves.

In the tail forming operation, the dovetail bit 101 moves upward and downward and thus forms tail grooves, thereby forming tails.

After the tail forming operation has been completed, the input unit 180 prepares to receive a command for a pin operation from the operator

(6) Operation of Removing the First Wood Panel Form the Horizontal Loading Platform

After the tail forming operation has been completed, the first wood panel 10 that is fixed on the horizontal loading platform 120 is removed from the horizontal loading platform 120.

Of course, an operation of releasing the first wood panel from the wood panel fastener 130 is conducted before the first wood panel 10 is removed from the horizontal loading platform.

(7) Operation of Loading the Second Wood Panel and Fixing it in Place

After the first wood panel 10 has been removed from the horizontal loading platform 120, the second wood panel 20 is horizontally disposed on the horizontal loading platform 120. Thereafter, the upper surface of the second wood panel 20 is held by the wood panel fastener 130 so that the second wood panel 20 is fixed in place.

(8) Operation of Changing the Bit into Another One

After the first wood panel removal operation has been completed, the dovetail bit 101 is removed from the spindle 141, and the spiral bit 101 is mounted to the spindle 141.

(9) Operation of Forming Pins

After the bit changing operation and the second wood panel fixing operation have been completed, the operator inputs a command to the input unit 180 for operation of forming pins.

Then, the control unit 170 controls to move the spindle mounting platform 140 provided with the spindle 141 having the spiral bit 101 in the vertical and lateral directions according to information input in the information input operation, thus forming pins in the second wood panel.

Here, the control unit 170 may store information about the diameter of the spiral bit 101 in advance and thus directly compute the path, along which the spiral bit 101 moves, according to the number, configuration, and shape of the pins that have been pre-computed. Alternatively, the control unit 170 may receive information of the diameter Ds of the spiral bit 101 in the information input operation and then compute the path along which the spiral bit 101 moves.

The processing path of the spiral bit 101 comprises an inclined path from the upper reference point to the lower reference point.

Although the preferred embodiment of the present invention has been disclosed, those skilled in the art will appreciate that various modifications, additions and substitutions are possible, without departing from the scope and spirit of the invention as disclosed in the accompanying claims. Therefore, it should be understood that the preferred embodiment is only for illustrative purposes and does not limit the bounds of the present invention. For instance, components that have been illustrated as being integrated with each other may be implemented in a separate structure, and components which have been illustrated as being separately provided may be provided in an integrated structure.

Therefore, it is intended that the bounds of the present invention are defined by the accompanying claims, and various modifications, additions and substitutions, which can be derived from the meaning, scope and equivalent concepts of the accompanying claims, fall within the bounds of the present invention.

### INDUSTRIAL APPLICABILITY

The present invention can be used in the industry related to processing wood panels.

1. A dovetail processing apparatus having a structure for horizontally loading a wood panel, the dovetail processing apparatus comprising:
a base frame;
a horizontal loading platform provided on an upper surface of the base frame so that the wood panel is horizontally loaded on the horizontal loading platform;
a spindle mounting platform disposed ahead of the base frame, with a spindle horizontally and rotatably mounted to the spindle mounting platform, the spindle being provided for installation of a processing bit;
a spindle-rotation drive unit provided on the spindle mounting platform so as to rotate the spindle;
a platform moving unit provided to move the spindle mounting platform at least in a vertical direction and a horizontal lateral direction perpendicular to an axial direction of the spindle; and
a control unit provided to control the spindle-rotation drive unit and the platform moving unit.

2. The dovetail processing apparatus of claim 1, wherein the control unit is connected to an input unit, the input unit receiving information about at least a maximum diameter of a dovetail bit, an angle of tails, a depth of the tails, and an overall length of a processing surface of the wood panel, and
the control unit comprises a processed-form computation unit computing a number, configuration, and shape of tails and pins to be formed according to the information input to the input unit, and a drive controller controlling the spindle-rotation drive unit and the platform moving unit according to the information computed by the processed-form computation unit.

3. The dovetail processing apparatus of claim 2, wherein the processed-form computation unit computes the number of tails to be formed using the information about the maximum diameter of the dovetail bit and the overall length of the processing surface of the wood panel.

4. The dovetail processing apparatus of claim 2, wherein the processed-form computation unit computes the number, configuration, and shape of pins to be formed depending on the number, configuration, and shape of tails to be formed.

5. The dovetail processing apparatus of claim 1, wherein the platform moving unit comprises:
a vertical moving block guided by the base frame so as to be vertically movable, the vertical moving block including a loading-platform horizontal-guide unit guiding horizontal lateral movement of the spindle mounting platform;
a vertical moving drive unit provided to vertically move the vertical moving block; and
a lateral moving drive unit provided on the vertical moving block and operated such that the spindle mounting platform can be moved along the loading-platform horizontal-guide unit in the horizontal lateral direction.

6. A dovetail processing method using a structure for horizontally loading a wood panel, the dovetail processing method comprising:
an operation of horizontally loading a first wood panel on a horizontal loading platform;
an operation of fixing the first wood panel on the horizontal loading platform in such a way that a wood panel fastener holds an upper surface of the first wood panel loaded on the horizontal loading platform;
an information input operation of inputting information about tails and pins to be formed to an input unit;
an operation of forming tails in the first wood panel using a dovetail bit in such a way that the control unit controls to move a spindle mounting platform upward, downward, leftward, and rightward according to the information input to the input unit, the spindle mounting platform being provided with a spindle to which the dovetail bit is mounted, the spindle being horizontally and rotatably provided;
an operation of removing the first wood panel loaded and fixed on the horizontal loading platform from the horizontal loading platform after the operation of forming the tails has been completed;
an operation of loading a second wood panel on the horizontal loading platform in the horizontal direction;
an operation of fixing the second wood panel on the horizontal loading platform in such a way that the wood panel fastener holds an upper surface of the second wood panel loaded on the horizontal loading platform;
a bit changing operation of removing the dovetail bit from the spindle and mounting a spiral bit to the spindle; and
an operation of forming pins in the second wood panel in such a way that the control unit controls to move the spindle mounting platform upward, downward, leftward, and rightward according to the information input in the information input operation, the spindle mounting platform being provided with the spindle to which the spiral bit is mounted,
wherein the tails of the first wood panel and the pins of the second wood panel can be coupled to each other in a dovetail joint manner.

7. A dovetail processing method using a structure for horizontally loading a wood panel, the dovetail processing method comprising:
an operation of horizontally loading a first wood panel on a horizontal loading platform;
an operation of fixing the first wood panel on the horizontal loading platform in such a way that a wood panel fastener holds an upper surface of the first wood panel loaded on the horizontal loading platform;
an information input operation of inputting information about tails and pins to be formed to an input unit;
an operation of forming pins in the first wood panel using a spiral bit in such a way that the control unit controls to move a spindle mounting platform upward, downward, leftward, and rightward according to the information input to the input unit, the spindle mounting platform being provided with a spindle to which the spiral bit is mounted, the spindle being horizontally and rotatably provided;
an operation of removing the first wood panel loaded and fixed on the horizontal loading platform from the horizontal loading platform after the operation of forming the pins has been completed;
an operation of loading a second wood panel on the horizontal loading platform in the horizontal direction;
an operation of fixing the second wood panel on the horizontal loading platform in such a way that the wood panel fastener holds an upper surface of the second wood panel loaded on the horizontal loading platform;
a bit changing operation of removing the spiral bit from the spindle and mounting a dovetail bit to the spindle; and
an operation of forming tails in the second wood panel in such a way that the control unit controls to move the spindle mounting platform upward, downward, leftward, and rightward according to the information input in the information input operation, the spindle mounting platform being provided with the spindle to which the dovetail bit is mounted,
wherein the pins of the first wood panel and the tails of the second wood panel can be coupled to each other in a dovetail joint manner.

8. The dovetail processing method of claim 6, wherein the information about the tails and pins input in the information input operation comprises information about at least a maximum diameter of the dovetail bit, an angle of the tails, a depth of the tails, and an overall length of a processing surface of the wood panel.

9. The dovetail processing method of claim 6, further comprising
an operation of computing a processing form after the information input operation in such a way that the control unit computes numbers, configurations, and shapes of tails and pins to be formed according to the information input in the information input operation.

10. The dovetail processing method of claim 9, wherein the operation of computing the processing form comprises computing a number, configuration, and shape of pins to be formed corresponding to a number, configuration, and shape of tails.
